(19) United States
(12) Patent Application Publication
(10) Pub. No.: US 2026/0340216 A1
(43) Pub. Date: Oct. 29, 2026

(54) PRECISE DIGITAL TWIN METHOD AND SYSTEM FOR ASSEMBLY OF HIGH-END MOTOR CORE DIE

(71) Applicant: Hangzhou Dianzi University, Hangzhou (CN)

(72) Inventors: Jiahui Qian, Hangzhou (CN); Yigang Wang, Hangzhou (CN); Zhijing Zhang, Hangzhou (CN); Wenyang Xiao, Hangzhou (CN); Yi Gao, Hangzhou (CN); Yibo Liu, Hangzhou (CN)

(21) Appl. No.: 19/649,522

(22) Filed: Apr. 16, 2026

(30) Foreign Application Priority Data
Apr. 24, 2025 (CN) 202510521536.6

(51) Int. Cl. G06F 30/17; G06F 111/06

(52) U.S. Cl. CPC G06F 30/17; G06F 2111/06

(57) ABSTRACT

Disclosed is a precise digital twin method and system for assembly of a high-end motor core die. The method includes performing point cloud data acquisition on all template holes and inserts in a die; performing fitting to form a curved surface on the basis of point cloud data of each template hole and insert; establishing a precise digital twin assembly model; and iteratively optimizing design positions of the template holes through interference fit simulation and a multi-objective parameter optimization solution. In this disclosure, a distance between a post-assembly hole center position of each template hole obtained from the simulation and an ideal position of the corresponding insert on the die is used as a fitness function. By integrating with a multi-objective genetic algorithm, the design positions of the template holes are rapidly iterated, and a design optimization efficiency of a high-end motor core die is improved.

### CROSS-REFERENCE TO RELATED APPLICATION

This application claims priority of Chinese Patent Application No. 202510521536.6, filed on Apr. 24, 2025, the entire contents of which are incorporated herein by reference.

### TECHNICAL FIELD

This disclosure belongs to the technical field of precise assembly of high-end motor core dies, and specifically relates to a precise digital twin method and system for assembly of a high-end motor core die.

### BACKGROUND

In the die industry, particularly in the high-end die manufacturing industry of motor cores for new energy vehicles, the die assembly process has a crucial impact on production and manufacturing. Due to the numerous hole positions on the die and the highly nonlinear nature of multiple shaft-hole interference fits, the interference fit deformation of the same size but different structures cannot be directly adjusted for assembly accuracy by the method of reverse compensation after deformation measurement. Moreover, there are significant structural differences among different dies. These problems render the analysis of assembly forces induced by interference fit exceedingly challenging, resulting in the difficult control of positional accuracy for template holes, thereby inevitably leading to reduced assembly efficiency, prolonged assembly cycles, and increased labor costs.

With the continuous improvement of the precision requirements for die processing and manufacturing, future die assembly tends towards high accuracy, low damage, and high efficiency. This means that the precise prediction of positional changes caused by force deformation during interference fit of high-end motor core dies is becoming increasingly important. The precision of such predictions directly correlates with the assembly accuracy and stability of dies, and is the key to achieving high-precision, low-damage and high-efficiency assembly. However, as assembly requirements increase, the difficulty of this prediction also rises. Although in-depth research into die assembly principles can provide theoretical support for high-precision assembly, in actual factory environments, when faced with a large number of dies of various shapes and sizes, accurately predicting the subtle changes of these dies remains one of the greatest challenges in the entire life manufacturing cycle of high-end motor core dies both at home and abroad.

### SUMMARY

In response to the problems in the prior art, an embodiment of this disclosure provides a prediction and optimization method for resisting assembly deformation in the high-end motor core die industry. By processing point cloud data, establishing a precise model that includes geometric distribution errors, and conducting simulations and optimizations on the model, the practical problems of low assembly efficiency and high labor costs in the high-end motor core die industry are solved.

In a first aspect, this disclosure provides a precise digital twin method for assembly of a high-end motor core die, including the following steps:
performing point cloud data acquisition on all template holes and corresponding inserts thereof in a die;
performing fitting to form a curved surface respectively on the basis of point cloud data of each template hole and insert;
establishing a precise digital twin assembly model for a template and each insert on the basis of the curved surface corresponding to each template hole and insert, and an ideal position of each insert on the die;
performing interference fit simulation between the inserts and the template holes for the precise digital twin assembly model, to obtain a post-assembly deformed hole center position of each template hole; and iteratively updating a design position of each template hole in the precise digital twin assembly model, allowing the post-assembly deformed hole center position of each template hole obtained from the simulation to close to the ideal position of each insert on the die.

The design position of the template hole is the specific processing position of the template hole in the die as indicated in the drawings.

In an embodiment, the design position of each template hole in the digital twin assembly model is iteratively updated by a multi-objective genetic method, with a fitness function of the multi-objective genetic method being a distance between the post-assembly deformed hole center position of the template hole obtained from the simulation and the ideal position of the corresponding insert on the die.

In an embodiment, the multi-objective genetic method includes:
(1) initializing population parameters: establishing an initial population by taking a set of design position coordinates for all the template holes on the template as individuals;
(2) performing interference fit simulation on each individual in a current population, and calculating the fitness function on the basis of simulation results;
(3) generating a new generation of population through selection, crossover, and mutation; and
(4) repeating step (2) to step (3) until convergence conditions are met or a maximum number of iterations is reached.

In an embodiment, the convergence conditions are that fitness function values corresponding to machining position coordinates of all the template holes in a same individual are all less than or equal to a preset permissible error threshold.

In an embodiment, for all generated individuals, deviations in horizontal and vertical coordinates between the design position of the template hole and the ideal position of the corresponding insert are all less than a preset displacement threshold; and the displacement threshold is preferably 20 μm.

In an embodiment, the point cloud data is subjected to the removal of gross errors, systematic errors, and random errors.

In an embodiment, the process of establishing the precise digital twin assembly model is: using a fitted assembly curved surface of the template hole as an assembly surface on the die to construct a precise three-dimensional digital twin model of the die; using the fitted assembly curved surface of the insert as an assembly surface on the insert to construct a precise three-dimensional digital twin model of the insert; and combining the precise three-dimensional digital twin model of the insert and the precise three-dimensional digital twin model of the die to form the precise digital twin assembly model.

In an embodiment, the process for establishing the precise three-dimensional digital twin model of the die is: first establishing a basic three-dimensional model of the die excluding template holes; and performing a Boolean subtraction operation using the assembly curved surface of each template hole at a design position thereof on the basic three-dimensional model of the die to obtain the precise three-dimensional digital twin model of the die.

In an embodiment, the process of the interference fit simulation is: assigning material properties, contact relationships, and boundary conditions to the precise digital twin assembly model with meshes divided; and performing interference fit simulation on each template hole and the corresponding insert in the precise digital twin assembly model, and outputting a hole center coordinate of each template hole after assembly deformation.

In a second aspect, this disclosure provides a precise digital twin system for assembly of a high-end motor core die, which is used to execute the method as described above. The precise digital twin system for assembly of the high-end motor core die includes a point cloud acquisition device, a modeling and simulation module, and a position optimization module. The point cloud acquisition device is configured to collect the point cloud data; and a three-coordinate measuring machine is preferably selected as the point cloud acquisition device. The modeling and simulation module is configured to establish the precise digital twin assembly model. The position optimization module is configured to iteratively optimize the design position of the template hole in the precise digital twin assembly model on the die.

This disclosure has the following advantageous effects.

1. In response to the assembly deformation problems commonly existing in the high-end motor core die industry, this disclosure provides a solution integrating digital twin technology. In this solution, by establishing a precise digital twin model and combining simulation technology with optimization algorithms, the design positions of template holes in the die are optimized, ensuring that the positions of the template holes, after undergoing interference fit deformation, align with the ideal positions of inserts, thereby enhancing the dimensional accuracy of a high-end motor core die after assembly.

2. In this disclosure, a distance between a post-assembly hole center position of each template hole obtained from the simulation and a corresponding ideal position of each insert on the die is used as a fitness function. By integrating with a multi-objective genetic algorithm, the design positions for the template holes are rapidly iterated, and a design optimization efficiency of a high-end motor core die is improved.

3. In this disclosure, a high-precision three-coordinate measuring machine is used to acquire point cloud data from the assembly surface of the assembly. The point cloud data is used to fit and generate the assembly curved surface, and on the basis of the assembly curved surface, a digital twin model with precise geometric information of the assembly curved surface is constructed in computer-aided engineering (CAE) software. This digital twin model integrates the geometric information, material properties, assembly poses, and contact relationships of the die, achieving more accurate prediction results of assembly deformation during simulations.

### BRIEF DESCRIPTION OF THE DRAWINGS

To state the technical solutions of this disclosure clearer, the attached drawings needed in the description of embodiments or prior art are stated briefly below. Obviously, the drawings described below are only some embodiments in this disclosure, and for those ordinary skilled in the art, other drawings can be obtained according to these drawings without creative efforts.

FIG. 1 is a schematic diagram showing the interference fit between a template hole and an insert of a die.

FIG. 2 is an overall flowchart according to an embodiment of this disclosure.

FIG. 3 is a flowchart showing the point cloud measurement process for a template hole and an insert in step S100 according to an embodiment of this disclosure.

FIG. 4 is a flowchart showing the point cloud data processing in step S200 according to an embodiment of this disclosure.

FIG. 5 is a flowchart showing a basic three-dimensional model modeling process in step S300 according to an embodiment of this disclosure.

FIG. 6 is a flowchart showing the generation of a precise digital twin assembly model in step S400 according to an embodiment of this disclosure.

FIG. 7 is a flowchart showing the simulation-based iterative optimization process for a design position of a template hole in step S500 according to an embodiment of this disclosure.

### DETAILED DESCRIPTION

For clearer objective, technical solutions and advantages of this disclosure, the technical solutions of the embodiments in this disclosure will be described clearly and completely by reference to the accompanying drawings of the embodiments in this disclosure below. Obviously, the embodiments described are only some, rather than all embodiments of this disclosure. On the basis of the embodiments of the disclosure, all other embodiments obtained by those ordinary skilled in the art without creative efforts fall within the scope of protection of the disclosure.

It is to be noted that, in this embodiment, the ideal surface or ideal model refers to a surface or model without geometric distribution errors, and the precise surface or precise model is a surface or model containing geometric distribution errors.

This disclosure is further described by reference to the accompanying drawings.

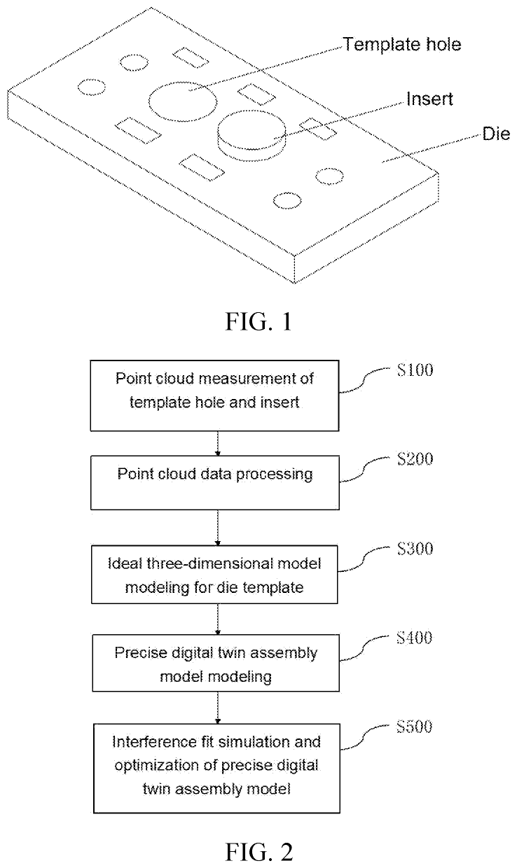

Referring to FIG. 1, which is a schematic diagram showing the interference fit between a template hole and an insert in a high-end motor core die according to this embodiment. It is particularly noteworthy that this embodiment can also be applied to high-end die assembly scenarios of varying sizes, shapes, and high-precision requirements. The process and results of a prediction and optimization method for resisting assembly deformation in a high-end motor core die provided by this embodiment are not affected by any external conditions of the die.

Referring to FIG. 2, which is an overall flowchart of the technical solutions in this embodiment. A precise digital twin method for assembly of a high-end motor core die includes the following steps.

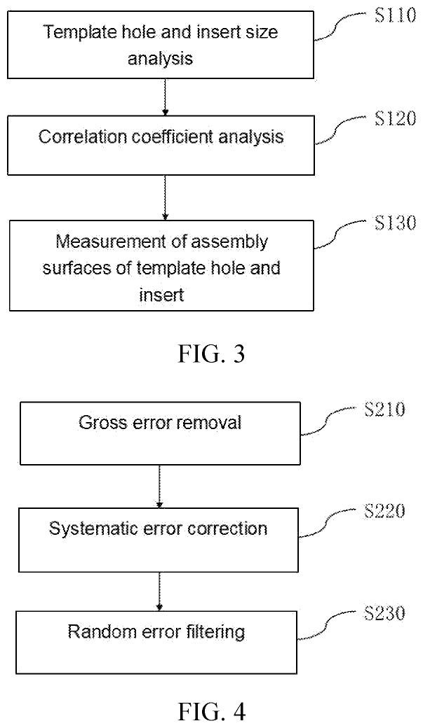

Step S100: point cloud measurement of template holes and inserts. As shown in FIG. 3, point cloud data measurement is performed on inner cylindrical surfaces of all the template holes and the corresponding outer cylindrical surfaces of inserts in the die on the basis of a high-precision three-coordinate measuring machine. An assembly surface of each template hole and the corresponding insert thereof obtains a set of point cloud data. This embodiment is applicable to the assembly of any number of template holes and inserts in the die, and is not limited by the shape and structure of the template holes, such as cylindrical holes, square holes, irregularly shaped holes, and corresponding inserts.

Before point cloud acquisition, it needs to perform statistical analysis on the quantity and dimensions of template holes and inserts, so as to obtain an optimal point cloud data measurement plan. The point cloud data measurement plan includes the interlayer spacing for sampling points and the spacing between adjacent points on each layer. The point cloud data measurement plan is determined on the basis of the calculation results of a Pearson correlation coefficient, thereby ensuring the efficiency and rationality of the measurement plan.

Step S200: point cloud data processing. Gross errors, systematic errors of the high-precision three-coordinate measuring machine, and random errors during the measurement process are sequentially removed from the measured point cloud data.

In this embodiment, it is to be noted that, in step S200, on the basis of the assembly surface point cloud data measured in step S100, gross errors and random errors are excluded in Matlab software. Reverse corrections are applied to the measured point cloud data in X, Y, and Z coordinates on the basis of systematic error correction experiments.

As shown in FIG. 4, step S200 specifically includes the following steps.

Step S210: gross error removal. On the basis of the Pauta criterion, gross errors are removed from the measured point cloud data of the assembly surfaces of the template holes and corresponding inserts of the die.

In this embodiment, it is to be noted that, in step S210, the gross error is defined as points where a difference between a straight-line distance dᵢ from a point cloud to the fitted circle center and an average distance d̅ exceeds three times the standard deviation (3σ). By removing the gross error points, the gross error removal step for the point cloud data is completed. The formulas for calculating the average distance d̅ and the standard deviation σ are:

$$\overline{d} = \frac{{\sum }_{i = 1}^{n} {d}_{i}}{n}$$

$$σ = \sqrt{\frac{{\sum }_{i = 1}^{n} {( {d}_{i} - \overline{d} )}^{2}}{n}}$$

Step S220: systematic error correction. Systematic error measurement experiments are conducted on the measuring machine, and the experimental results are used to perform reverse correction of systematic errors on the point cloud data that has undergone gross error removal.

In this embodiment, it is to be noted that, in step S220, the systematic error correction experiment involves using a high-precision surface of a standard rectangular gauge block as a reference plane, allowing a nominal length direction of the gauge block to parallel to the X, Y, and Z directions of the three-coordinate measuring machine, respectively, repeating point measurements, and calculating the differences from the nominal distances to obtain the systematic errors f_{X}, f_{Y} and f_{Z} of the high-precision three-coordinate measuring machine used for measurement, compensating and correcting the X, Y, and Z coordinates of the point cloud data, and outputting the point cloud data after systematic error correction.

Step S230: random error filtering. On the basis of median filtering, random error filtering is performed on the point cloud data that has undergone systematic error correction to obtain processed point cloud data for subsequent calculations.

In this embodiment, it is to be noted that, in step S230, median filtering is used to eliminate random errors from the point cloud data that has undergone systematic error correction using Matlab software, thereby obtaining point cloud data of the assembly surfaces of the template holes and the inserts that has completed all point cloud data processing tasks and is ready for subsequent calculations.

Step S300: basic three-dimensional model modeling of die template. On the basis of the CAD drawings of the high-end motor core die template, the basic three-dimensional model of the die template is established in the three-dimensional modeling software.

In this embodiment, it is to be noted that, in step S300, the CAD two-dimensional drawings (excluding template holes) of the high-end motor core die are processed in AutoCAD software, and the three-dimensional ideal model of the template is established in Solidworks three-dimensional modeling software. It is to be particularly noted that this embodiment does not impose restrictions on the model type and file format, and the obtained basic three-dimensional model does not include the template holes to be assembled.

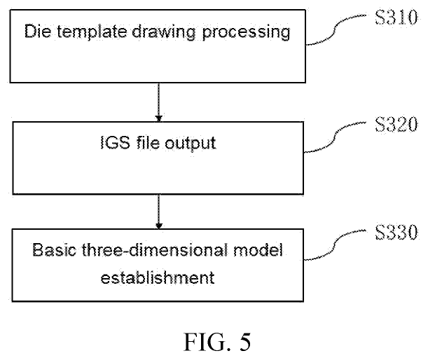

As shown in FIG. 5, step S300 specifically includes the following steps.

Step S310: die template drawing processing. The CAD drawings of the high-end motor core die template are processed.

In this embodiment, it is to be noted that, in step S310, the specific drawing processing method involves retaining only the structural parts on the CAD drawings and removing the template holes to be assembled and other annotations or data.

Step S320: IGS file export. The processed CAD drawings are outputted in IGS format.

In this embodiment, it is to be noted that, in step S320, it specifically involves converting the CAD drawings processed in step S310 into IGS format.

Step S330: basic three-dimensional model establishment. On the basis of Solidworks three-dimensional modeling software, the IGS-format drawings are read and are subjected to extrusion operations to establish a basic three-dimensional model without the template holes.

In this embodiment, it is to be noted that, in step S330, the basic three-dimensional model is a three-dimensional model without geometric distribution errors. In Solidworks three-dimensional modeling software, the IGS file exported in step S320 is read to extrude the two-dimensional drawings into a basic three-dimensional model without template holes that have surfaces with geometric errors.

Step S400: precise digital twin assembly model modeling. On the basis of the basic three-dimensional model without geometric distribution errors, NURBS curved surface modeling theory, and Boolean subtraction operations, a precise three-dimensional assembly model with geometric distribution errors is generated; and physical conditions are added to the precise three-dimensional assembly model to generate the precise digital twin model.

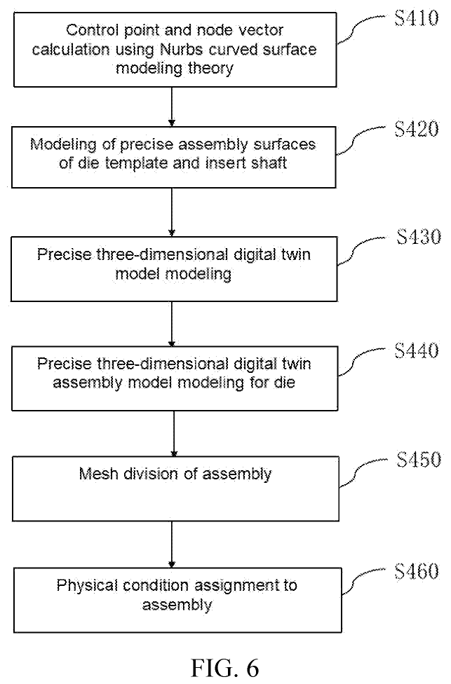

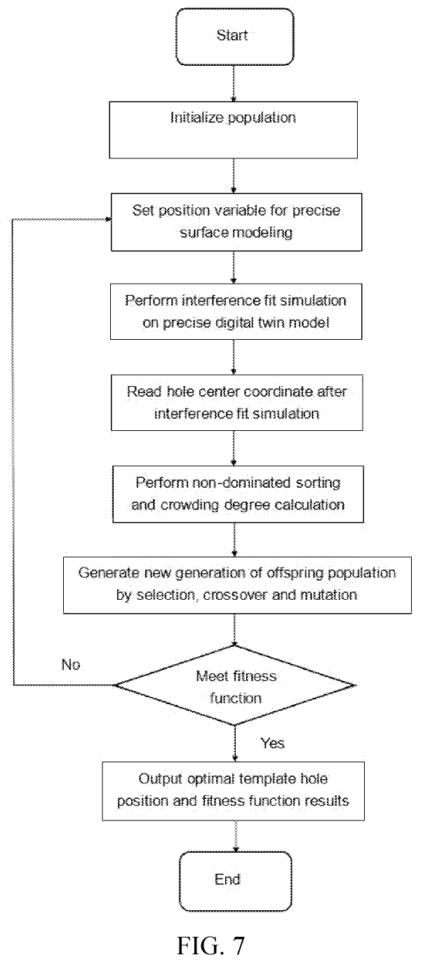

As shown in FIG. 6, step S400 specifically includes the following steps.

Step S410: a NURBS curved surface is constructed on the basis of the point cloud data corresponding to each assembly surface. The process of constructing the NURBS curved surface includes obtaining node parameters and curve node vectors corresponding to the measured data points in the point cloud data through the cumulative chord length method, and generating the NURBS curved surface accordingly. This specific process is a conventional method and will not be elaborated herein.

Step S420: precise assembly surfaces with the geometric distribution errors are generated on the basis of the NURBS curved surface, including the precise assembly surfaces of the die template holes and the precise assembly surfaces of the corresponding inserts. It is to be noted that, during the generation of the precise assembly surface, the heights of the assembly surfaces with geometric distribution errors are made slightly greater than the die thickness by adjusting the Z-coordinates of the topmost and bottommost point clouds. This aims to ensure that subsequent Boolean subtraction operations can form the template holes penetrating two ends of the basic three-dimensional model.

Step S430: the basic three-dimensional model without template holes generated in step S300 and the precise assembly surface of the template hole with geometric distribution errors generated in step S420 are imported into Comsol software. The import position of the central axis of the precise assembly surface of the template hole is the design position coordinates of the corresponding template holes on the die. Boolean subtraction operations are performed on the three-dimensional die model without assembly holes using the precise assembly surface with geometric distribution errors, and then the separated parts and the precise assembly surfaces of the template holes are deleted. At this point, template holes with precise geometric distribution error information are generated on the basic three-dimensional model, thereby obtaining the precise three-dimensional digital twin model of the die.

Boolean subtraction operations are performed on a rectangular three-dimensional solid model with a thickness consistent with that of the die using the precise assembly surface of the insert, and the independent part cut out is retained as the precise three-dimensional digital twin model of the insert.

Step S440: the precise three-dimensional digital twin model of the die and the precise three-dimensional digital twin model of the insert generated in step S430 are imported into CAE simulation software for assembly, thereby generating a precise three-dimensional digital twin assembly model of the die with geometric distribution errors.

Step S450: mesh division is performed on the precise digital twin assembly model using a mesh sweeping method. The mesh elements employ C3D8R.

Step S460: corresponding physical conditions are assigned to the precise digital twin assembly model. Material properties are assigned on the basis of the respective material characteristics of the die template and the insert. The contact relationships between the assembly surfaces and the application of boundary conditions are set for the assembly. This precise digital twin assembly model can accurately represent the actual die template holes and insert assembly in terms of both physical properties and geometric shapes.

In this embodiment, it is to be noted that, in step S450, the physical conditions assigned to the assembly include material properties, boundary conditions, temperature environment, contact relationships between the die template holes and the inserts, assembly positions and orientations, etc.

In some other embodiments, a method for constructing the precise digital twin assembly model is as follows. First, an ideal three-dimensional model containing an ideal die hole is established according to the drawings, and mesh division is performed on the ideal three-dimensional model, with a surface of the ideal die hole being cylindrical; a NURBS curved surface is established on the basis of the point cloud data; all surface mesh nodes on an assembly surface of the ideal three-dimensional model are offset to the NURBS curved surface constructed in step S410, with each surface mesh node being offset to a nearest interpolation point or an extreme point, and the assembly surface of the ideal three-dimensional model is transformed from an ideal cylindrical surface to the NURBS curved surface. In some further embodiments, interpolation points that are at a distance less than a threshold from the extreme points are removed. This ensures that each extreme point can be influenced by the offset of a surface mesh node, enabling the offset surface mesh to better represent the topography of the NURBS curved surface. Finally, on the basis of offset amounts of all the surface mesh nodes, internal nodes of the ideal three-dimensional model are adjusted according to the principle of smoothness, to ensure the convergence of the mesh quality, and the precise digital twin assembly model is obtained. This approach can avoid the difficulties of directly performing mesh division on a precise digital twin assembly model with complex curved surfaces.

Step S500: simulation-based iterative optimization of the design position of template holes. The precise digital twin assembly model obtained in step S400 is used to conduct interference fit simulations of the die template holes and corresponding inserts in CAE simulation software. On the basis of the simulation results, through the interaction between the multi-objective genetic algorithm and the simulation of the precise digital twin assembly model, the design positions of the template holes on the die are continuously iterated. This ensures that the optimized results of the interference fit between the die template holes and the corresponding inserts meet the high-precision and high-efficiency requirements for the manufacturing and assembly of actual high-end motor core dies.

As shown in FIG. 6, step S500 specifically includes the following steps.

Step S510: initial position variable setting for template hole. The ideal position coordinates of each insert on the die are indicated by the ideal hole center coordinates of each template hole on the die drawings. The ideal hole center coordinates of each template hole on the die drawings are used as the initial design position coordinates for the template holes.

In this embodiment, it is to be noted that, in step S510, initial simulations are conducted on the basis of the ideal positions of the template holes in the CAD drawings. That is, when subsequently integrating with the multi-objective optimization algorithm, the initial population consists of the X and Y coordinates of each template hole on the template. It is to be noted that the variables being modified are the positions for Boolean subtraction operations between the precise surfaces of the template holes from step S420 and the ideal three-dimensional solid model of the die template, and the assembly positions in step S430. These variables are then imported into the CAE simulation software using Python code.

Step S520: interference fit simulation of the precise digital twin assembly model.

Preprocessing and simulation of interference fit for each template hole and the corresponding insert thereof in the precise digital twin assembly model are performed within the CAE software.

In this embodiment, it is to be noted that, in step S520, preprocessing for simulation is carried out on the basis of the CAE simulation software. This preprocessing includes setting node sets for the mesh nodes on all assembly surfaces of the template holes and inserts in the precise digital twin model. After preprocessing, simulation calculations for interference fit assembly between the template holes and inserts in the precise digital twin assembly model are performed.

Step S530: the deformed hole center coordinates of each template hole obtained from the simulation are read and outputted.

In this embodiment, it is to be noted that, in step S530, it involves reading and outputting the coordinates of all nodes in the node sets after the interference fit simulation calculations. On the basis of these node coordinates, least squares fitting is performed to obtain the hole center positions of the template holes on the die after simulation.

Step S540: multi-objective genetic method. The hole center positions of the template holes are optimized and iterated on the basis of a multi-objective optimization algorithm. After each iteration, steps S520 and S530 are re-executed to obtain updated hole center coordinates after interference fit, thereby integrating simulation with the optimization algorithm. During the iteration process, the deformed hole center coordinates after interference fit gradually approach the ideal hole center coordinates. In this embodiment, the fitness function of the multi-objective genetic method is the distance between the deformed hole center coordinates after interference fit obtained from the simulation and the ideal hole center coordinates. When the fitness functions corresponding to all template holes reach the preset permissible error threshold, the convergence condition of the optimization algorithm can be met in advance. The flowchart of the multi-objective genetic algorithm is shown in the figure.

The specific process of the multi-objective genetic method is as follows.

(1) Population parameters are initialized: a set of values of the design position coordinates of all template holes on the template are taken as an individual, and a plurality of individuals are set to establish an initial population. In this embodiment, the number of populations is set to 20, and the maximum number of iterations is set to 50. The variation range for the horizontal and vertical coordinates of the hole center of each template hole is set to ±20 μm.

(2) Simulations are conducted for each individual in the current population according to the processes in steps S520 and S530, and the fitness function is calculated on the basis of the simulation results. If no individual in the current population meets the convergence condition, non-dominated sorting is performed on all individuals according to fitness function of the current population. The population individuals are stratified on the basis of the dominance relationships among different individuals in the current population to identify the non-dominated solutions in the current population.

In this embodiment, the convergence condition is that the fitness function values corresponding to the design position coordinates of all template holes in the same individual are all less than or equal to the preset permissible error threshold. The value of the permissible error threshold is set according to the precision requirements. In this embodiment, the permissible error threshold is set to 5 μm. In other embodiments, the permissible error threshold can also be set to 2 μm, 6 μm, 8 μm, 10 μm, or other values.

(3) Parent individuals are selected on the basis of the results of the non-dominated sorting in step (2). On the basis of the parent individuals, a new generation of offspring population is generated through selection, crossover, and mutation.

(4) For the new generation of population, step (2) to step (3) are repeated, and iteration is continued until convergence conditions are met or a maximum number of iterations is reached.

In this embodiment, the interference fit simulation of the precise digital twin model is combined with a multi-objective optimization algorithm. By employing a multi-objective genetic method and iteratively modifying the design positions of the template holes, the positions after simulation are read and outputted via node sets, and the fitness function is calculated, achieving this integration of simulation and optimization algorithms, significantly enhancing the optimization efficiency of the design position coordinates for the template holes and scientifically guiding the process parameters for high-end motor core die enterprises.

In response to the problem of difficulty in analysis of assembly deformation in high-end motor core dies, this embodiment provides a prediction and optimization method based on a precise digital twin model. This method accurately predicts the positional deviation caused by extrusion deformation after interference fit of the template holes. Moreover, the initial design positions of the template holes are optimized using a multi-objective genetic optimization algorithm, ensuring that the positional deviations of each template hole after interference fit remain within the permissible error range. This disclosure scientifically guides the process parameters in the high-end motor core die industry, effectively solving the most significant assembly deformation problem currently existing in the die industry.

In summary, this embodiment provides a prediction and optimization method for resisting assembly deformation in the high-end motor core die industry. By utilizing a high-precision precise digital twin model in conjunction with CAE simulation software and a multi-objective optimization algorithm, the deformation caused by interference fit in dies is predicted and the initial design positions of the template holes are scientifically guided. This method not only significantly reduces the scrap rate in the production and manufacturing of high-end motor core dies but also enhances assembly efficiency, substantially lowering labor and time costs for die enterprises. Moreover, this method ensures precision in the production of cores for high-end motor core dies, greatly promoting the high-precision, high-efficiency, and low-cost development of the die manufacturing industry.

1. A precise digital twin method for assembly of a high-end motor core die, comprising the following steps:
performing point cloud data acquisition on all template holes and corresponding inserts thereof in a die;
performing fitting to form a NURBS curved surface respectively on the basis of point cloud data of each template hole and insert;
establishing a precise digital twin assembly model for a template and each insert on the basis of the NURBS curved surface corresponding to each template hole and insert, and an ideal position of each insert on the die, wherein
a method for constructing the precise digital twin assembly model is: first establishing an ideal three-dimensional model containing an ideal die hole according to the drawings, and performing mesh division on the ideal three-dimensional model, with a surface of the ideal die hole being cylindrical; offsetting all surface mesh nodes on an assembly surface of the ideal three-dimensional model to the NURBS curved surface, with each surface mesh node being offset to a nearest interpolation point or an extreme point, transforming the assembly surface of the ideal three-dimensional model from an ideal cylindrical surface to the NURBS curved surface; and adjusting internal nodes of the ideal three-dimensional model according to the principle of smoothness on the basis of offset amounts of all the surface mesh nodes, to obtain the precise digital twin assembly model;
performing interference fit simulation between the inserts and the template holes for the precise digital twin assembly model, to obtain a post-assembly deformed hole center position of each template hole; and iteratively updating a design position of each template hole in the precise digital twin assembly model, allowing the post-assembly deformed hole center position of each template hole obtained from the simulation to close to the ideal position of each insert on the die; and
iteratively updating the design position of each template hole in the digital twin assembly model by a multi-objective genetic method, with a fitness function of the multi-objective genetic method being a distance between the post-assembly deformed hole center position of the template hole obtained from the simulation and the ideal position of the corresponding insert on the die.

2. The precise digital twin method for assembly of the high-end motor core die according to claim 1, wherein the multi-objective genetic method comprises:
(1) initializing population parameters: establishing an initial population by taking a set of design position coordinates for all the template holes on the template as individuals;
(2) performing interference fit simulation on each individual in a current population, and calculating the fitness function on the basis of simulation results;
(3) generating a new generation of population through selection, crossover, and mutation; and
(4) repeating step (2) to step (3) until convergence conditions are met or a maximum number of iterations is reached.

3. The precise digital twin method for assembly of the high-end motor core die according to claim 2, wherein the convergence conditions are that fitness function values corresponding to machining position coordinates of all the template holes in a same individual are all less than or equal to a preset permissible error threshold.

4. The precise digital twin method for assembly of the high-end motor core die according to claim 2, wherein for all generated individuals, deviations in horizontal and vertical coordinates between the design position of the template hole and the ideal position of the corresponding insert are all less than a preset displacement threshold.

5. The precise digital twin method for assembly of the high-end motor core die according to claim 1, wherein the point cloud data is subjected to the removal of gross errors, systematic errors, and random errors.

6. The precise digital twin method for assembly of the high-end motor core die according to claim 1, wherein the process of the interference fit simulation is: assigning material properties, contact relationships, and boundary conditions to the precise digital twin assembly model with meshes divided; and performing interference fit simulation on each template hole and the corresponding insert in the precise digital twin assembly model, and outputting a hole center coordinate of each template hole after assembly deformation.

7. A precise digital twin system for assembly of a high-end motor core die, used to execute the method according to claim 1, comprising a point cloud acquisition device, a modeling and simulation module, and a position optimization module, wherein the point cloud acquisition device is configured to collect the point cloud data; the modeling and simulation module is configured to establish the precise digital twin assembly model; and the position optimization module is configured to iteratively optimize the design position of the template hole in the precise digital twin assembly model on the die.
